(19) United States
(12) Patent Application Publication
(10) Pub. No.: US 2005/0217496 A1
(43) Pub. Date: Oct. 6, 2005

(54) Method and apparatus for making pancakes

(75) Inventor: John N. Dodgen, Humboldt, IA (US)

Correspondence Address: ZARLEY LAW FIRM P.L.C., CAPITAL SQUARE, 400 LOCUST, SUITE 200, DES MOINES, IA, 50309-2350, US

(73) Assignee: DODGEN INDUSTRIES, INC., Humboldt, IA (US)

(21) Appl. No.: 10/816,757

(22) Filed: Apr. 2, 2004

(51) Int. Cl. A47J 9/00

(52) U.S. Cl. 99/422

(57) ABSTRACT

The present invention is directed toward a method and apparatus for preparing pancakes that retain condiments such as maple syrup and butter, thereby preventing the condiments from spreading to other breakfast items and otherwise creating a mess. A cooking surface is provided. At least one raised member is secured to the cooking surface. In this fashion, pancake batter can be poured on the cooking surface, and the raised member creates a hole in the center of the pancake. A spatula device also is provided for use in preparing pancakes on the griddle of the present invention. The spatula is provided with a notched portion in the scraper blade such that the blade clears the raised member of the cooking surface and permits turning of the pancakes. A method for preparing said pancakes also is provided.

### BACKGROUND OF THE INVENTION

The present invention relates to pancakes and, more specifically, to a method and apparatus for preparing pancakes that retain condiments.

Pancakes are a popular breakfast item enjoyed by millions of households every morning. Many people like to pile up a stack of pancakes and top it off with a pat of butter and maple syrup. Although preferences may vary, most people enjoy a generous coating of maple syrup on their pancakes.

One problem with enjoying pancakes, particularly when covered with butter and maple syrup, is that they create quite a mess. It is often difficult to keep the maple syrup from spreading beyond the pancakes. This is especially problematic when the pancakes share the plate with other breakfast items, such as eggs and bacon. Many people do not like the maple syrup interfering with their eggs and bacon.

It is therefore a principal object of this invention to provide a method and apparatus for making pancakes that retain condiments such as maple syrup and butter, thereby preventing the maple syrup and butter from spreading to other breakfast items and otherwise creating a mess.

A further object of this invention is to provide cookware for preparing pancakes.

These and other objects will be apparent to those skilled in the art.

### BRIEF SUMMARY OF THE INVENTION

The present invention is directed toward a method and apparatus for preparing pancakes that retain condiments such as maple syrup and butter, thereby preventing the condiments from spreading to other breakfast items and otherwise creating a mess. A cooking surface, such as a stovetop grill or a frying pan is provided. At least one raised member is secured to the cooking surface, said raised member having a circular cross section. In this fashion, pancake batter can be poured on the cooking surface, and the raised member creates a hole in the center of the pancake. The hole retains the maple syrup and butter and allows the consumer to dispense the maple syrup and butter as desired.

A spatula device also is provided for use in preparing pancakes on the griddle of the present invention. The spatula is provided with a notched portion in the scraper blade such that the blade clears the raised member of the cooking surface and permits turning of the pancakes.

A method for preparing pancakes that retain the condiments also is provided.

### BRIEF DESCRIPTION OF THE DRAWINGS

FIG. 1 is a perspective view of a pancake griddle of the present invention with a pancake that retains condiments; and

FIG. 2 is a plan view of a spatula device of the present invention for use in preparing pancakes that retain condiments.

### DESCRIPTION OF THE PREFERRED EMBODIMENTS OF THE INVENTION

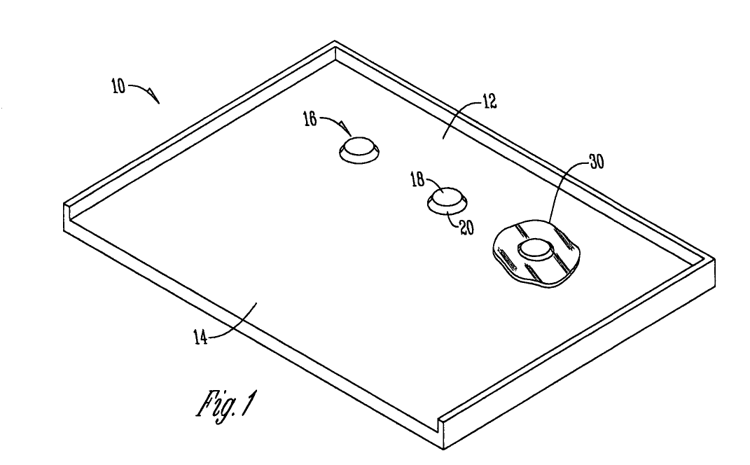

With reference to FIG. 1, a cooking surface 10 is provided. The cooking surface has a first half 12 and a second half 14. As shown in FIG. 1, the first half 12 is positioned rearward of the second half 14. The cooking surface 10 preferably is a conventional griddle or stovetop grill. Alternatively, the cooking surface 10 may include a frying pan or any other conventional cooking surface used in the frying of pancakes.

A raised member 16 is secured to the cooking surface 10. The raised member 16 has a top 18 and sloping sides 20. The raised member 16 preferably has a circular cross section. Although the dimensions of the raised surface 16 may vary as desired, the raised member 16 is approximately two inches in diameter and approximately half of an inch in height. Alternatively, the raised member 16 may be separate from the cooking surface 10 such that a consumer may set the raised member 16 onto the cooking surface 10 when desiring to cook pancakes. In this arrangement, the raised member 16 may be removed after the pancakes are made, allowing the cooking surface 10 to be used in a regular manner.

Alternatively, the cooking surface 10 includes a plurality of raised members 16. As shown in FIG. 1, the cooking surface 10 has three raised members 16 positioned in a row in the rearward half 12 of the cooking surface 10. Alternatively, the cooking surface 10 includes a plurality of rows having a plurality of raised members 16, as desired. It is contemplated that home consumers would desire a cooking surface 10 having one row of three or fewer raised members 16, as shown in FIG. 1. Restaurants may desire a cooking surface 10 having two or more rows of three or more raised members 16.

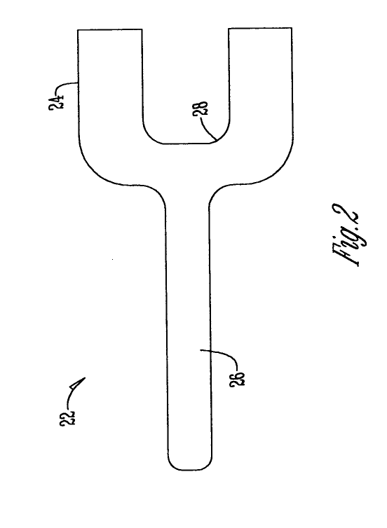

With reference to FIG. 2, a spatula 22 is provided for use in preparing pancakes with the cooking surface 10 of the present invention. A scraper blade 24 is secured to an elongated handle 26. The scraper blade 24 is U-shaped forming a notched portion 28 in the center of the scraper blade 24, as shown in FIG. 2. The notched portion creates two scraping edges on scraper blade 24. Although the dimensions of the notched portion 28 may vary as desired, the notched portion 28 is generally rectangular in shape, having a width of approximately two inches and a length of at least two inches to accommodate and receive a raised member 16.

When preparing pancakes, pancake batter 30 is poured onto the cooking surface 10 around the raised member 16. The raised member 16 creates a hole in the center of the pancake forming a generally donut-shaped pancake, as shown in FIG. 1. The spatula 22 is used to flip and remove the pancake from the cooking surface 10. Specifically, the notched portion 28 of the spatula 22 receives the raised member 16 while the scraping blade 24 is positioned between the pancake and the cooking surface 10 for flipping and removing the pancake. While frying pancakes on the rearward half 12 of the cooking surface 10 shown in FIG. 1, a consumer is free to fry other breakfast items, such as bacon and eggs, on the front half 14 of the cooking surface 10. Because the pancakes prepared with the cooking surface 10 will have a hole in their center, the pancakes will be able to retain condiments such as maple syrup and butter, thereby preventing the condiments from spreading to other breakfast items and otherwise creating a mess. In this arrangement, a consumer is free to dispense the maple syrup and butter onto the pancakes as desired.

It is therefore seen that by the use of a raised surface secured to the cooking surface, the present invention permits pancakes to be prepared with a hole in the center for use in containing the maple syrup and butter and preventing unwanted mess.

1. A device for making pancakes comprising:
a cooking surface; and
at least one raised member secured to the cooking surface.

2. The device of claim 1 further comprising a spatula having a scraper blade secured to an end of a handle, the scraper blade formed to receive the raised member.

3. The device of claim 1 wherein the cooking surface has a plurality of raised surfaces.

4. The device of claim 1 wherein the raised surface is located in a rearward half of the cooking surface.

5. The device of claim 1 wherein the cooking surface comprises a stovetop grill.

6. The device of claim 1 wherein the cooking surface comprises a frying pan.

7. The device of claim 1 wherein the raised member is releasably secured to the cooking surface.

8. A spatula device for use with making pancakes comprising:
a handle; and
a scraper blade secured to an end of the handle having a notched portion formed in the center of the scraper blade.

9. A method of making pancakes that retain condiments comprising:
providing a cooking surface with at least one raised member;
pouring pancake batter on the cooking surface substantially around the raised member;
providing a spatula having a scraper blade secured to an end of a handle, the scraper blade formed to receive the raised member;
flipping the pancake about the raised member with the spatula; and
removing the pancake from the cooking surface with the spatula.

10. A breakfast item comprising:
a pancake substantially round in shape; and
a center portion removed from the pancake for retaining condiments.
